(19) United States
(12) Patent Application Publication
(10) Pub. No.: US 2006/0187820 A1
(43) Pub. Date: Aug. 24, 2006

(54) Vector routing-revised

(76) Inventor: Daren French, Irvine, CA (US)

Correspondence Address: XROADS NETWORKS;SUITE 112, 17165 VON KARMAN, IRVING, CA, 92614, US

(21) Appl. No.: 11/062,335

(22) Filed: Feb. 22, 2005

(51) Int. Cl. H04L 12/26

(52) U.S. Cl. 370/227; 718/105; 370/389

(57) ABSTRACT

A device used to combine two or more diverse network paths to increase the amount of bandwidth available both to and from external networks and a local network by dividing traffic between the network paths and provide for redundancy in the event of a network path failure by determining overall diverse path loads and availability.

### REFERENCES CITED

Vector Routing White Paper, September 2001.

Vector Routing provisional patent filed June 2001.

Request for comments 2992, November 2000.

Request for comments 2391, August 1998.

Request for comments 2136, April 1997.

Request for comments 1794, April 1995.

Request for comments 1322, May 1992.

Request for comments 1247, July 1991.

Request for comments 1034, November 1987.

Request for comments 1035, November 1987.

### BACKGROUND

In computer networks, such as the Internet, preventing a smaller portion of the network, or local network (one with only several connections to the rest of the network), from losing connectivity to the rest of the network can be accomplished by providing redundant paths to various points within the larger network.

The Internet as a whole is based on a routing scheme that uses IP address information in order to determine where a packet of information needs to be sent.

This invention aims to assist local networks gain better access to larger external networks by using a combination of vectors, or diverse multiple paths to the larger external network.

Many products today are capable of providing connections to two or more diverse paths and use a variety of methods to determine when those paths are available or not available.

The problem is that many of these methods rely on complicated routing protocols to determine whether the path is acceptable for transmitting data traffic over it or not. Beyond being complicated, these routing protocols do not do a very good job of determining how well the path is performing for the end user. As long as data traffic is able to get to its remote destination, the path is used.

Several “network load balancing” products/methods have attempted to solve that problem by probing of the local networks two or more diverse gateway routers in an attempt to determine the load of these gateways.

The problem with these solutions is that the load of the local gateway provides little to no information about the overall status of the network path that the local networks traffic is following. Issues that arise beyond the local gateway, within the local service providers network, or even within the 1^{st} tier provider which provides transit for the local service provider, are not detected with this method, and thus do not provide true network redundancy and/or failover from one end of the communications session to the other.

### SUMMARY

The present invention seeks to provide a novel apparatus and method for efficiently and accurately redirecting end-to-end communications sessions over the most appropriate network path when two or more diverse network paths are available to the apparatus.

There is thus provided in accordance with a preferred embodiment of the present invention a method for Vector Routing diverse path selection based on the continued measurement of multiple remote nodes via two or more diverse network paths to a larger external network. By monitoring these remote nodes and gathering specific data measurements via each diverse network path, the Vector Routing module (software code) running on the apparatus can determine which diverse path traffic should sent.

In accord with the path selection by the Vector Routing module a DNS daemon running on the apparatus can also be updated so that only those IP addresses of the network interfaces which a associated with the active network paths are provided in DNS responses to request made from external DNS clients.

Those responses have a limited TTL (time to live) value and include all of the IP addresses of the network interfaces which are associated with the active network paths. These addresses are provided in an order defined in RFC 1034/1035.

The purpose of using diverse network path monitoring and route selection based on the analysis of the monitoring is to replace the existing complex and costly routing protocols used by many network routers today while still providing a more detailed status of the overall network path that many routing protocols do very well.

### DESCRIPTION OF DRAWINGS

The present invention can be understood and better appreciated from the following detailed description, taken in conjunction with the following drawing:

FIG. 1—A pictorial illustration of a typical network session constructed and operative in accordance with the preferred embodiment of the present invention.

### DETAILED DESCRIPTION OF PREFERRED EMBODIMENTS

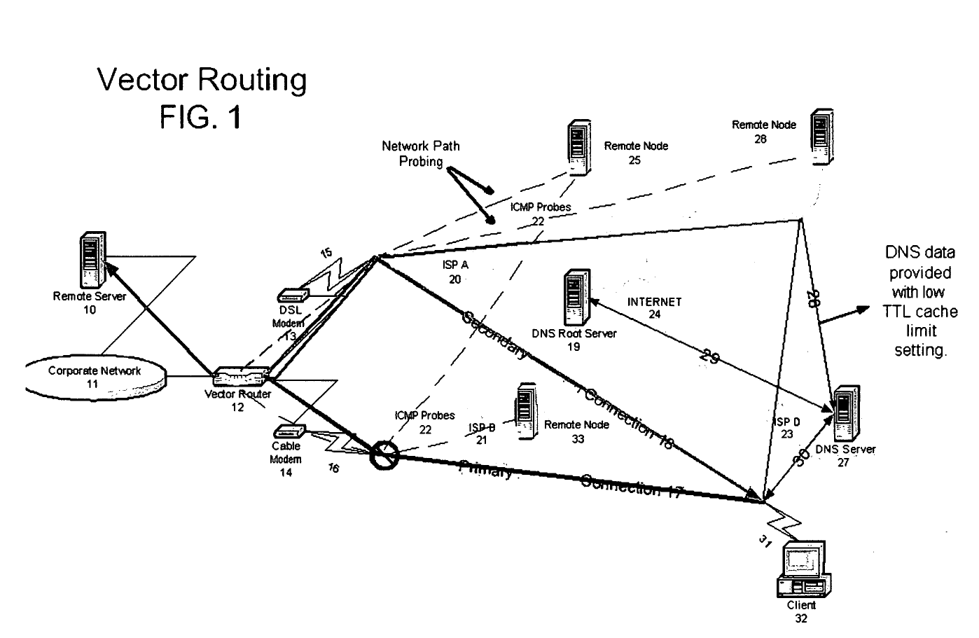

Reference is now made to FIG. 1 that provides the general flow of vector routing. Vector Routing in this diagram consists of two diverse network paths connected to a computing device which is running the Vector Routing module (software code). The two networks paths consist of broadband connection devices 13 and 14, logical broadband data connections 16, their associated networks 20 and 21 and the larger external network (in this case the Internet) 24. To ensure that the local network 11 has the is optimally using the two diverse network paths, the Vector Routing apparatus 12 sends probes via ICMP to multiple remote nodes 25, and 26 via both networks 20 and 21 to gather network measurements for those remote nodes via each network path, including latency, packet loss, and calculated jitter. These measurements are then stored within the Vector Routing apparatus for later comparison and manipulation by the Vector Routing algorithm to determine whether each diverse network path is still within the acceptable range and whether the route for that path should remain in the apparatus' routing table and DNS daemon.

Assume that for some reason the network path through ISP B 21 is unable to provide connectivity from vector router 12 to the remote nodes 25 and 28. The vector router 12 would detect this via its probing and algorithm and change its routing table to reflect this change. The Vector Routing module within the vector router 12 apparatus would also set all IP addresses assigned to the apparatus' network interface card of associated non-acceptable network path within the DNS daemon to inactive thus causing DNS responses to no longer provide those IP addresses to DNS clients. During the next interval that the client 32 requests the DNS information for the remote server 10, the address has been updated and now the client 32 will use the secondary inbound connection 18 through ISP A 20 to maintain the communication session(s).

1. A method for combining two or more diverse network paths in order to obtain higher data transfer rates and provide redundancy for network traffic between a local network and a larger external network (like the Internet) by probing multiple remote nodes through the two or more diverse network paths. These probes gather information which is then used by an algorithm to determine whether any of the paths are within the predetermined acceptable availability range. If the path is no longer within the acceptable range, the routing table of the computing device is change such that the non-acceptable path is removed, thus network traffic no longer uses such path. The IP address of the network interface card which is associated to the non-acceptable path is also set to an inactive state within the computing devices DNS responder daemon. If all paths are within the acceptable range traffic is equally divided between the paths.

2. The method of claim 1, wherein the computing device includes a CPU, read only memory, writeable memory, software which contains executable code which is stored in memory and operates the processor, and three or more network interface connectors.

3. The method of claim 1, wherein the remote nodes are designated by IP address and are updated using secure client/server code which ensures the correct IP addresses are being used.

4. The method of claim 3, wherein the client code resides on the computing device and the server code resides on a remote computing device and the client code contacts the remote computing device at a predetermined schedule and obtains the current list of IP addresses which should be proved.

5. The method of claim 1, wherein the probes are modified ICMP packets which are used to obtain measurements of the remote nodes and those measurements are included in a calculation of a particular paths availability and performance.

6. The method of claim 1, wherein the path selection criteria is determined by sending probes to multiple remote nodes via each of the diverse network paths to determine whether each network path is providing acceptable connectivity to the larger external network.

7. The method of claim 1, wherein the modified ICMP packets include predefined values in the data portion of the packet which assists in determining path acceptability. Other measurements provided by the ICMP response include latency, packet loss, and calculated jitter information. All of the response information is stored in a database for future comparison.

8. The method of claim 1, wherein a predetermined weight for each of the remote nodes is assigned.

9. The method of claim 1, wherein an algorithm obtains the measurement information from the probes and compares them to the predetermined weights for each remote node.

10. The method of claim 1, wherein the algorithm determines whether a particular network path is outside the acceptable range using these measurements in combination with the weights assigned to each remote node.

11. The method of claim 1, wherein the DNS responder daemon (RFC 1034/1035 1987 & 2136 1997) uses a dynamic updating system to change the IP addresses provided in response to requests by external DNS clients. The responses include a short TTL (time to live) value and all acceptable NIC addresses.
